(19) United States
(12) Patent Application Publication
(10) Pub. No.: US 2007/0256444 A1
(43) Pub. Date: Nov. 8, 2007

(54) Water supplying apparatus and refrigerator having the same

(75) Inventors: Seon-ho Kim, Gwangju-city (KR); Jin-oh Seok, Gwangju-city (KR); Seok-jun Son, Gwangju-city (KR); Eun-hee Jung, Gwangju-city (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/716,549

(22) Filed: Mar. 12, 2007

(30) Foreign Application Priority Data
May 8, 2006 (KR) 10-2006-0041185

(51) Int. Cl. B67D 5/62

(52) U.S. Cl. 62/390

(57) ABSTRACT

A water supplying apparatus which includes a cold water pipe supplying a cold water, a hot water pipe supplying a hot water, and a dispenser connected with the cold water pipe and the hot water pipe. The dispenser includes a housing comprising a cold water inlet through which cold water supplied from the cold water pipe flows in, a hot water inlet through which hot water supplied from the hot water pipe flows in, and a single outlet through which the hot water or the cold water flows out, an inlet regulating part reciprocating in the housing to selectively open the cold water inlet and the hot water inlet, and an outlet regulating part opening and closing the outlet. Thus, the present invention provides a water supplying apparatus and a refrigerator having the same selectively supplying a hot water and a cold water by using a single lever.

### CROSS-REFERENCE TO RELATED APPLICATIONS

This application claims benefit of Korean Patent Application No. 10-2006-0041185, filed on May 8, 2006, in the Korean Intellectual Property Office, the disclosure of which is incorporated herein by reference.

### BACKGROUND OF THE INVENTION

1. Field of the Invention

The present invention relates to a water supplying apparatus and a refrigerator having the same. More particularly, to a water supplying apparatus and a refrigerator having the same selectively supplying a hot water and a cold water by using a single lever.

2. Description of the Related Art

Generally, a conventional water supplying apparatus supplies a user with water stored in a storing tank or at an outside. The water supplying apparatus includes a cold/hot water supplier and a water purifier. The water supplying apparatus supplies cold water and hot water. The water supplying apparatus includes a cold water tank storing cold water, a hot water tank storing hot water, and a dispenser connected with the cold water tank and the hot water tank and supplying the cold water and the hot water. The dispenser includes a cold water lever for supplying the cold water and a hot water lever for supplying the hot water.

A conventional refrigerator includes the water supplying apparatus to enhance convenience of a user. The water supplying apparatus or a home bar is typically provided to a front surface of a door thereof.

As mentioned above, the water supplying apparatus provided to the conventional refrigerator supplies cold water and hot water by a cold water lever and a hot water lever.

Since the conventional water supplying apparatus separately includes the cold water lever and the hot water lever, and thus cost and the volume thereof increase.

### SUMMARY OF THE INVENTION

Accordingly, it is an aspect of the present invention to provide a water supplying apparatus and a refrigerator having the same selectively supplying hot water and cold water by using a single lever.

Additional aspects and/or advantages of the invention will be set forth in part in the description which follows and, in part, will be apparent from the description, or may be learned by practice of the invention.

The foregoing and/or other aspects of the present invention can be achieved by providing a water supplying apparatus including a cold water pipe supplying a cold water, a hot water pipe supplying a hot water, and a dispenser connected with the cold water pipe and the hot water pipe, the dispenser including a housing having a cold water inlet through which a cold water supplied from the cold water pipe flows in, a hot water inlet through which a hot water supplied from the hot water pipe flows in, and a single outlet through which the hot water or the cold water selectively flows out, an inlet regulating part reciprocating in the housing to selectively open the cold water inlet and the hot water inlet, and an outlet regulating part opening and closing the outlet.

According to an aspect of the present invention, when the inlet regulating part opens the cold water inlet and the outlet regulating part opens the outlet, the dispenser supplies the cold water, and when the inlet regulating part opens the hot water inlet and the outlet regulating part opens the outlet, the dispenser supplies the hot water.

According to an aspect of the present invention, the inlet regulating part includes a rod in the housing to move between a cold water supplying position at which the cold water inlet is opened and the hot water inlet is closed, and a hot water supplying position at which the hot water inlet is opened and the cold water inlet is closed, a hot water packing part provided to the rod and closing the hot water inlet when the rod is at the cold water supplying position, a cold water packing part provided to the rod and closing the cold water inlet when the rod is at the hot water supplying position, an elastic member elastically pressing the rod toward the cold water supplying position, and an operating part operating the rod.

According to an aspect of the present invention, the inlet regulating part includes a rod in the housing to move between a cold water supplying position at which the cold water inlet is opened and the hot water inlet is closed, and a hot water supplying position at which the hot water inlet is opened and the cold water inlet is closed, a water channel part connecting the cold water inlet with the outlet when the rod is at the cold water supplying position, and connecting the hot water inlet with the outlet when the rod is at the hot water supplying position, an elastic member elastically pressing the rod toward the cold water supplying position, and an operating part operating the rod.

According to an aspect of the present invention, the water channel part includes a groove formed around an outer surface of the rod.

According to an aspect of the present invention, the water channel part includes a through hole formed to the rod.

According to an aspect of the present invention, the water channel part includes a cold water channel and a hot water channel distanced each other.

The foregoing and/or other aspects of the present invention can be achieved by providing a refrigerator including a water supplying apparatus, the water supplying apparatus including a cold water pipe supplying a cold water, a hot water pipe supplying a hot water, and a dispenser connected with the cold water pipe and the hot water pipe, the dispenser including a housing including a cold water inlet through which a cold water supplied from the cold water pipe flows in, a hot water inlet through which a hot water supplied from the hot water pipe flows in, and a single outlet through which the hot water or cold water selectively flows out, an inlet regulating part reciprocating in the housing to selectively open the cold water inlet and the hot water inlet, and an outlet regulating part opening and closing the outlet.

According to an aspect of the present invention, the dispenser includes an input part to select the cold water or the hot water.

According to an aspect of the present invention, the refrigerator further includes a hot water valve opening and closing the hot water pipe, a valve switch operating the hot water valve, and a control part controlling the valve switch to open the hot water valve when the hot water is selected through the input part.

According to an aspect of the present invention, the refrigerator further includes a cold water valve opening and closing the cold water pipe, wherein the valve switch operates the cold water valve, and the control part controls the valve switch to open the cold water valve if the cold water is selected through the input part.

According to an aspect of the present invention, the valve switch interlocks with the outlet regulating part.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A is a sectional view illustrating a water supplying apparatus according to a first embodiment of the present invention;

FIG. 1B is a sectional view illustrating a state in which the water supplying apparatus in FIG. 1A supplies cold water;

FIG. 1C is a sectional view illustrating a state in which the water supplying apparatus in FIG. 1a supplies hot water;

FIG. 2A is a sectional view illustrating a water supplying apparatus according to a second embodiment of the present invention;

FIG. 2B is a sectional view illustrating a state in which the water supplying apparatus in FIG. 2a supplies cold water;

FIG. 2C is a sectional view illustrating a state in which the water supplying apparatus in FIG. 2A supplies hot water;

FIGS. 3A and 3B are sectional views illustrating other aspects of the water supplying apparatus in FIG. 2A;

FIG. 4 is a perspective view schematically illustrating a refrigerator according to an embodiment of the present invention; and

FIG. 5 is a control flow chart of the refrigerator in FIG. 4.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below to explain the present invention by referring to the figures.

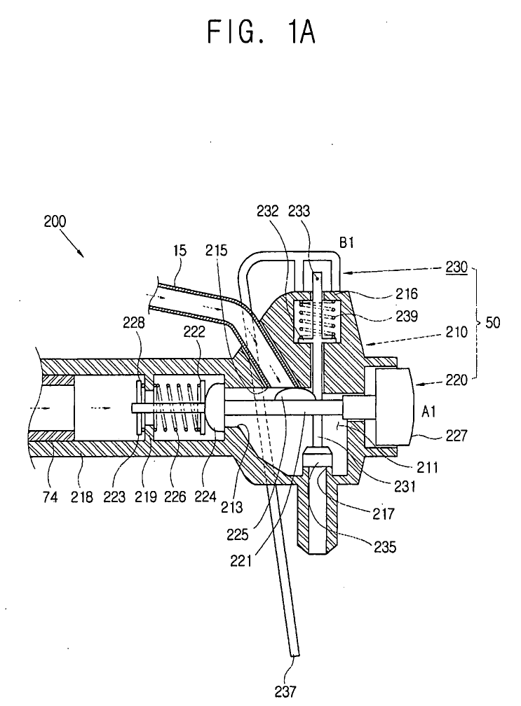

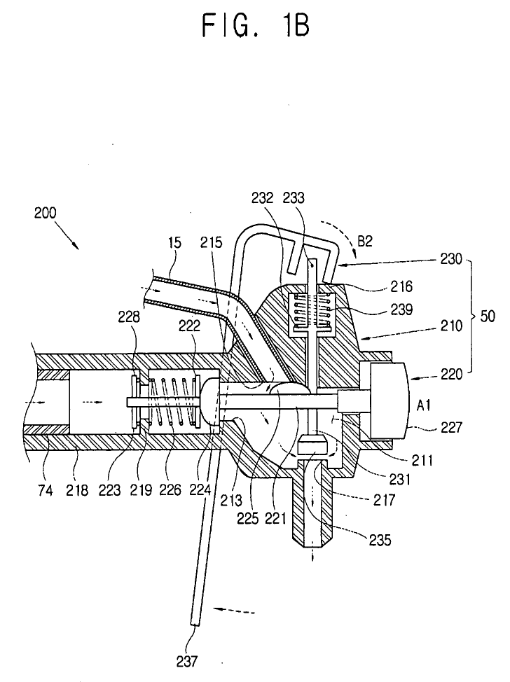

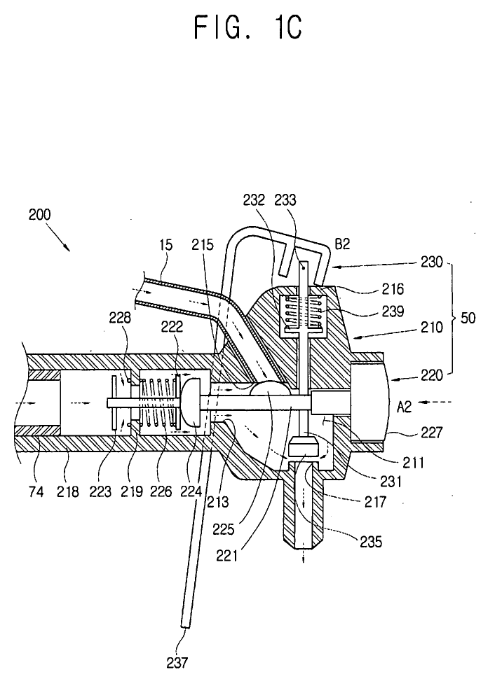

As shown in FIGS. 1A to 1C, a water supplying apparatus 200 according to a first embodiment of the present invention comprises a main body (not shown), a cold water pipe 15 to supply cold water, a hot water pipe 74 to supply hot water, and a dispenser 50 connected with the cold water pipe 15 and the hot water pipe 74.

The dispenser 50 comprises a housing 210 comprising a cold water inlet 215 through which the cold water in the cold water pipe 15 flows in, a hot water inlet 213 through which the hot water in the hot water pipe 74 flows in, and a single outlet 217 through which the cold water or the hot water selectively flows out. The dispenser 50 comprises an inlet regulating part 220 selectively opening and closing the cold water inlet 215 and the hot water inlet 213, and an outlet regulating part 230 opening and closing the outlet 217. That is, as shown in FIG. 1A, for example, cold water and hot water selectively flows out of the same outlet 217.

An inner space 211 is formed inside the housing 210. The hot water inlet 213 is disposed to a rear part of the inner space 211 of the housing 210, and the cold water inlet 215 is disposed to an upper part of the inner space 211 thereof. The outlet 217 is disposed to a lower part of the inner space 211 thereof.

The cold water pipe 15 is connected with the cold water inlet 215. According to an embodiment of the present invention, the cold water inlet 215 comprises a size corresponding to a cold water packing part 225.

The hot water pipe 74 is connected with the hot water inlet 213. According to an embodiment of the present invention, the hot water inlet 213 has a size corresponding to a hot water packing part 224 or smaller than the hot water packing part 224.

The outlet 217 comprises a pipe shape, and protrudes from a lower part of the housing 210. However, the outlet of the present invention is not limited to any particular shape and may vary accordingly.

The inlet regulating part 220 is coupled with the housing 210 to move forward and backward in the inner space 211. The inlet regulating part 220 includes an inlet rod 221 moving forward and backward inside the housing 210, the hot water packing part 224 is provided to the inlet rod 221 to open and close the hot water inlet 213, the cold water packing part 225 is provided to the inlet rod 221 to open and close the cold water inlet 215, an inlet elastic member 226 elastically biasing the inlet rod 221, and an operating part 227 operating the inlet rod 221.

The inlet rod 221 reciprocates in frontward and backward directions in the inner space 211 of the housing 210. The inlet rod 221 reciprocates between a cold water supplying position A1 at which the cold water inlet 215 is opened and the hot water inlet 213 is closed, and a hot water supplying position A2 at which the hot water inlet 213 is opened and the cold water inlet 215 is closed. The operating part 227 is coupled to a front of the inlet rod 221, and the inlet elastic member 226 is coupled to a rear thereof.

The hot water packing part 224 is provided to the inlet rod 221, and reciprocates to open and close the hot water inlet 213 depending on moving of the inlet rod 221. When the inlet rod 221 is positioned at the cold water supplying position A1, the hot water packing part 224 closes the hot water inlet 213 to prevent the hot water from flowing in the inner space 211 of the housing 210. According to an embodiment of the present invention, the hot water packing part 224 is formed of rubber, a silicon material having elasticity, etc. Thus, the hot water packing part 224 can stably close the hot water inlet 213 in the cold water supplying position A1.

The cold water packing part 225 is provided to the inlet rod 221, and reciprocates to open and close the cold water inlet 215 depending on moving of the inlet rod 221. When the inlet rod 221 is positioned at the hot water supplying position A2, the cold water packing part 225 closes the cold water inlet 215 to prevent the cold water from flowing in the inner space 211 of the housing 210. According to an embodiment of the present invention, the cold water packing part 225 is formed of rubber, a silicon material having elasticity, etc. Thus, the cold water packing part 225 can stably close the cold water inlet 215 in the hot water supplying position A2.

The inlet elastic member 226 elastically presses the inlet rod 221 so that the inlet rod 221 maintains the cold water supplying position A1. The inlet elastic member 226 comprises a coil spring. The inlet rod 221 comprises a first engaging protrusion 222 supporting the inlet elastic member 226. Thus, the inlet rod 221 can be stably biased by the inlet elastic member 226. Alternatively, the inlet elastic member 226 may directly press the hot water packing part 224 so that the inlet rod 221 maintains the cold water supplying position A1. Thus, according to an embodiment of the present invention, the first engaging protrusion 222 can become unnecessary.

A hot water pipe coupling part 218 extends backward from the hot water inlet 213 of the housing 210. A first elastic supporting part 219 protrudes around an inner surface of the hot water pipe coupling part 218 of the housing 210. It is preferable that the inside diameter of the first elastic supporting part 219 is bigger than the outer diameter of the inlet rod 221. Thus, the housing 210 can support the inlet elastic member 226, and the inlet elastic member 226 can stably press the inlet rod 221.

An O-ring 228 is at a rear of the first elastic supporting part 219 to seal therebetween. A second engaging protrusion 223 protrudes around a rear end part of the inlet rod 221 which is positioned in rear of the O-ring 228.

The operating part 227 operates the inlet rod 221. The operating part 227 is provided to a front end part of the inlet rod 221 to move the inlet rod 221 between the cold water supplying position A1 and the hot water supplying position A2. The operating part 227 comprises a button which is capable of being pushed against elasticity of the inlet elastic member 226.

The outlet regulating part 230 comprises an outlet rod 231, an outlet packing part 235 provided to a first end of the outlet rod 231 to open and close the outlet 217, a lever 237 hingedly connected with a second end of the outlet rod 231, and an outlet elastic member 239 elastically pressing the lever 237.

The outlet rod 231 reciprocates in upward and downward directions in the inner space 211 of the housing 210. The outlet rod 231 reciprocates between an opening position B2 at which the outlet 217 is opened and a closing position B1 at which the outlet 217 is closed. The outlet packing part 235 is coupled with a lower part of the outlet rod 231, and the outlet elastic member 239 is coupled to an upper part thereof.

The outlet packing part 235 is provided to the outlet rod 231, and reciprocates to open and close the outlet 217 depending on a movement of the outlet rod 231. When the outlet rod 231 is positioned in the closing position B1, the outlet packing part 235 prevents the cold water or the hot water from flowing out to the outside. According to an embodiment of the present invention, the outlet packing part 235 is formed of rubber, a silicon material having elasticity, etc. Thus, the outlet packing part 235 can stably close the outlet 217 in the closing position B1.

The lever 237 operates the outlet rod 231 so that the outlet rod 231 moves between the opening position B2 and the closing position B1. The lever 237 is hingedly connected with the outlet rod 231. When the lever 237 is pushed backward to rotate about a hinge shaft 233, the outlet rod 231 moves to the opening position B2 so that the outlet packing part 235 opens the outlet 217.

The outlet elastic member 239 elastically presses the outlet rod 231 so that the outlet rod 231 maintains the closing position B1. The outlet elastic member 239 comprises a coil spring. The outlet rod 231 comprises a third engaging protrusion 232 supporting the outlet elastic member 239. Thus, the outlet rod 231 can be stably biased by the outlet elastic member 239.

A second elastic supporting part 216 is provided to an upper part of the housing 210 to support the outlet elastic member 239. According to an embodiment of the present invention, the inside diameter of the second elastic supporting part 216 is bigger than the outside diameter of the outlet rod 231. Thus, the housing 210 can support the outlet elastic member 239, and the outlet elastic member 239 can stably press the outlet rod 231.

Hereinafter, an operation of the water supplying apparatus 200 will be described by referring to FIGS. 1A to 1C.

Referring to FIG. 1B, when a user is supplied with cold water, if the user pushes the lever 237 backward, the lever 237 rotates about the hinge shaft 233 to raise the outlet rod 231. The user should apply a force to overcome an elastic force of the outlet elastic member 239. As the outlet rod 231 is raised, the outlet 217 is opened. Here, since the inlet elastic member 226 of the inlet regulating part 220 presses the inlet rod 221 to maintain the cold water supplying position A1, the cold water supplied from the cold water pipe 15 can flow out through the outlet 217.

Referring to FIG. 1C, when a user is supplied with a hot water, the user pushes the operating part 227 of the inlet regulating part 220 to move the inlet rod 221 to the hot water supplying position A2. The user should apply a force to overcome an elastic force of the inlet elastic member 226. Depending on moving of the inlet rod 221, the hot water packing part 224 opens the hot water inlet 213 and the cold water packing part 225 closes the cold water inlet 215. Then, when the user pushes the lever 237 backward, the hot water supplied from the hot water pipe 74 can flow out through the outlet 217.

Accordingly, the water supplying apparatus 200 can efficiently and stably supply cold water and hot water by means of one lever 237, thereby simplifying the configuration thereof and reducing cost and the size thereof.

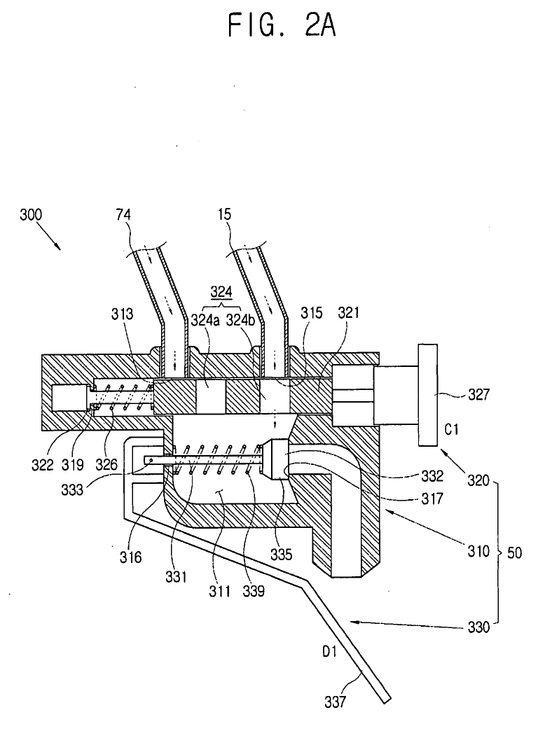

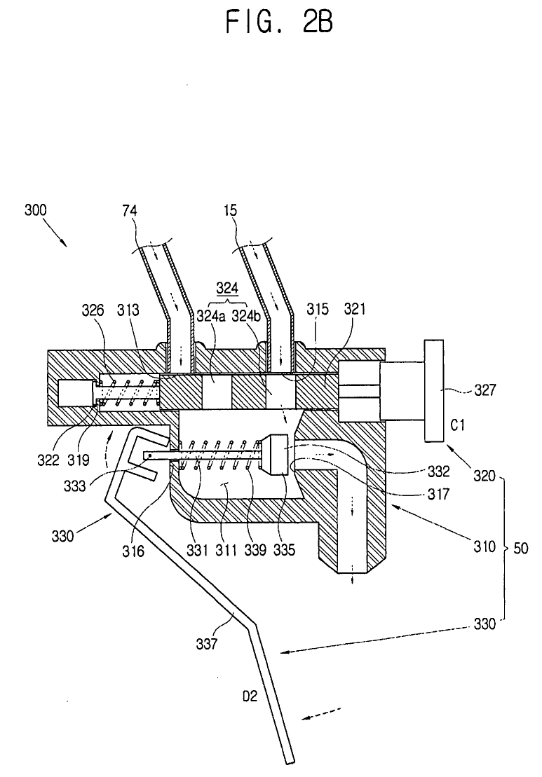

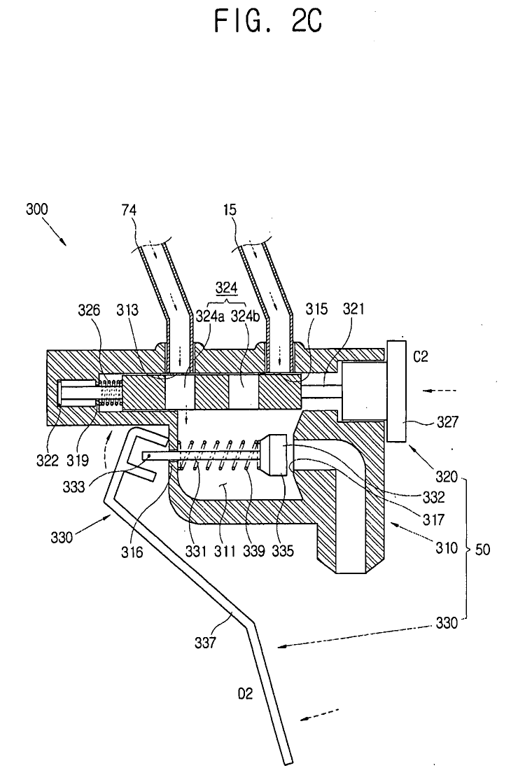

Hereinafter, a water supplying apparatus according to a second embodiment of the present invention will be described by referring to FIGS. 2A to 2C.

As shown in FIGS. 2A to 2C, a water supplying apparatus 300 according to a second embodiment of the present invention includes a main body (not shown), a cold water pipe 15 supplying a cold water, a hot water pipe 74 supplying a hot water, and a dispenser 50 connected with the cold water pipe 15 and the hot water pipe 74. According to an embodiment of the present invention, the cold water pipe 15 and the hot water pipe 74 are arranged in parallel.

The dispenser 50 comprises a housing 310 including a cold water inlet 315 through which the cold water of the cold water pipe 15 flows therein, a hot water inlet 313 through which the hot water of the hot water pipe 74 flows in, and a single outlet 317 through which the cold water or the hot water selectively flows out, an inlet regulating part 320 selectively opening and closing the cold water inlet 315 and the hot water inlet 313; and an outlet regulating part 330 opening and closing the outlet 317.

An inner space 311 is formed inside the housing 310. The hot water inlet 313 is disposed to a first upper part of the inner space 311 of the housing 310, and the cold water inlet 315 is disposed to a second upper part of the inner space 311 thereof. The outlet 317 is disposed to a lower part of the inner space 311 thereof.

The cold water pipe 15 is connected with the cold water inlet 315. The cold water inlet 315 comprises a size corresponding to a cold water channel 324b.

The hot water pipe 74 is connected with the hot water inlet 313. The hot water inlet 313 comprises a size corresponding to a hot water channel 324a.

The outlet 317 comprises a pipe shape bent downward to protrude from a lower part of the housing 310.

The inlet regulating part 320 is coupled with the housing 310 to move forward and backward in the inner space 311. The inlet regulating part 320 includes an inlet rod 321 moving forward and backward inside the housing 310, a water channel part 324 provided to the inlet rod 321 to selectively open the hot water inlet 313 and the cold water inlet 315, an inlet elastic member 326 elastically pressing the inlet rod 321, and an operating part 327 operating the inlet rod 321.

The inlet rod 321 reciprocates in frontward and backward directions in the inner space 311 of the housing 310. The inlet rod 321 reciprocates between a cold water supplying position C1 at which the cold water inlet 315 is opened and the hot water inlet 313 is closed, and a hot water supplying position C2 at which the hot water inlet 313 is opened and the cold water inlet 315 is closed. The operating part 327 is coupled to a front of the inlet rod 321, and the inlet elastic member 326 is coupled to a rear thereof. A rod protrusion 322 is provided to a rear end part of the inlet rod 321 and supported by a protrusion supporting part 319 to prevent the inlet rod 321 from separating from the housing 310.

The water channel part 324 connects the cold water inlet 315 to the outlet 317 when the inlet rod 321 is positioned at the cold water supplying position C1, and connects the hot water inlet 313 to the outlet 317 when the inlet rod 321 is positioned at the hot water supplying position C2. The water channel part 324 is provided to the inlet rod 321, and opens the hot water inlet 313 in the hot water supplying position C2 and opens the cold water inlet 315 in the cold water supplying position C1 depending on moving of the inlet rod 321.

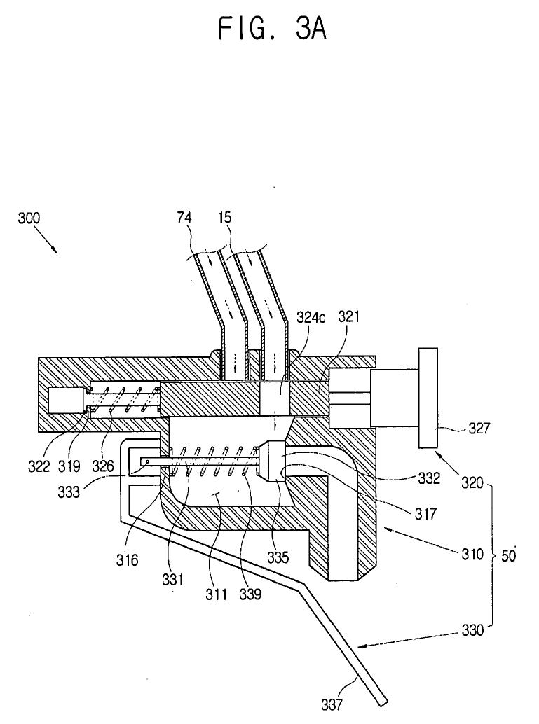

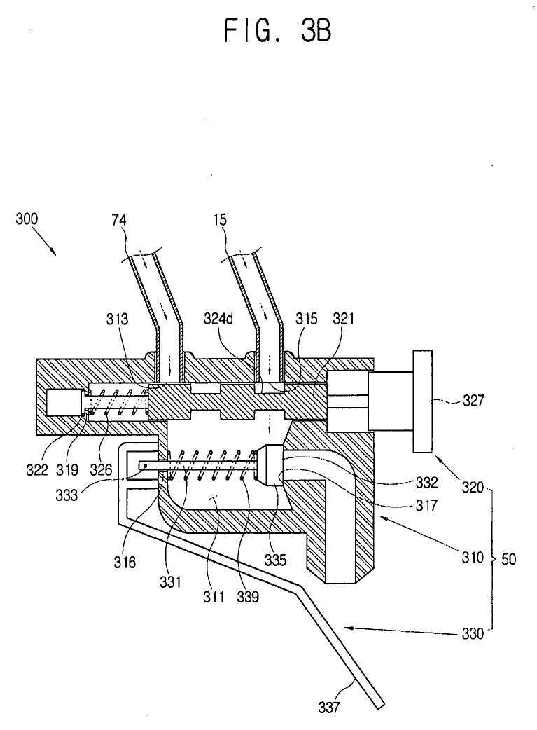

The water channel part 324 comprises the cold water channel 324b and the hot water channel 324a distanced each other. The cold water channel 324b and the hot water channel 324a are separately provided to the inlet rod 321. Alternatively, in the embodiment of the present invention as shown in FIG. 3A, the cold water channel 324b and the hot water channel 324a are integrally provided thereto such as a single water channel 324c. The cold water channel 324b and the hot water channel 324a are provided as through holes formed to the inlet rod 321. Alternatively, in the embodiment of the present invention as shown in FIG. 3B, the cold water channel 324b and the hot water channel 324a comprise grooves formed on the inlet rod 321 such as a water channel 324d. Also, alternatively, the cold water channel 324b and the hot water channel 324a comprise one groove integrally formed thereon according to an embodiment of the present invention.

The cold water channel 324b is provided to the inlet rod 321, and selectively opens the cold water inlet 315 depending on moving of the inlet rod 321. The cold water channel 324b is formed through a first part of the inlet rod 321. When the inlet rod 321 is positioned at the cold water supplying position C1, the cold water channel 324b connects the cold water inlet 315 with the outlet 317.

The hot water channel 324a is provided to the inlet rod 321, and selectively opens the hot water inlet 313 depending on moving of the inlet rod 321. The hot water channel 324a is formed through a second part of the inlet rod 321. When the inlet rod 321 is positioned at the hot water supplying position C2, the hot water channel 324a connects the hot water inlet 313 with the outlet 317.

According to an embodiment of the present invention, the distance between the cold water channel 324b and the hot water channel 324a is smaller than the distance between the cold water inlet 315 and the hot water inlet 313. Thus, the cold water channel 324b connects the cold water inlet 315 with the outlet 317, and the hot water inlet 313 is closed by the inlet rod 321 in the cold water supplying position C1. Also, the hot water channel 324a connects the hot water inlet 313 with the outlet 317, and the cold water inlet 315 is closed by the inlet rod 321 in the hot water supplying position C2. Alternatively, according to an embodiment of the present invention, the distance between the cold water channel 324b and the hot water channel 324a, and the distance between the cold water inlet 315 and the hot water inlet 313 are relatively determined variously depending on a disposing order of the cold water inlet 315 and the hot water inlet 313, pushing or pulling of the operating part 327, and a pressing direction of the inlet elastic member 226 with respect to the inlet rod 321.

The inlet elastic member 326 elastically presses the inlet rod 321 so that the inlet rod 321 maintains the cold water supplying position C1. According to an embodiment of the present invention, the inlet elastic member 326 comprises a coil spring. A rear part of the inlet rod 321 to which the inlet elastic member 326 is coupled comprises a diameter smaller than that of a front part of the inlet rod 321. Also, the diameter of the inlet elastic member 326 is bigger than that of the rear part of the inlet rod 321, and smaller than that of the front part of the inlet rod 321. Thus, the inlet elastic member 326 can stably press the inlet rod 321. Alternatively, the inlet rod 321 and the inlet elastic member 326 have such an engaging configuration as the water supplying apparatus 200 according to the first embodiment of the present invention.

The operating part 327 operates the inlet rod 321. The operating part 327 is provided to a front end part of the inlet rod 321 to move the inlet rod 321 between the cold water supplying position C1 and the hot water supplying position C2. The operating part 327 comprises a button which is capable of being pushed against pressing of the inlet elastic member 326.

The outlet regulating part 330 comprises an outlet rod 331, an outlet packing part 335 provided to a first end part of the outlet rod 331 to open and close the outlet 317, a lever 337 hingedly connected with a second end part of the outlet rod 331, and an outlet elastic member 339 elastically pressing the lever 337.

The outlet rod 331 reciprocates in forward and backward directions under the inlet regulating part 320 in the inner space 311 of the housing 310. The outlet rod 331 reciprocates between an opening position D2 at which the outlet 317 is opened and a closing position D1 at which the outlet 317 is closed. The outlet packing part 335 is coupled with a front part of the outlet rod 331, and the outlet elastic member 339 is coupled with a rear part thereof.

The outlet packing part 335 is provided to the outlet rod 331, and reciprocates to open and close the outlet 317 depending on moving of the outlet rod 331. When the outlet rod 331 is positioned in the closing position D1, the outlet packing part 335 prevents the cold water or the hot water from flowing out to the outside. According to an embodiment of the present invention, the outlet packing part 335 is formed of rubber, a silicon material having elasticity, etc. Thus, the outlet packing part 335 can stably close the outlet 317 in the closing position B1.

The lever 337 operates the outlet rod 331 so that the outlet rod 331 moves between the opening position D2 and the closing position D1. The lever 337 is hingedly connected with the outlet rod 331. If the lever 337 is pushed backward or forward to rotate about a hinge shaft 333, the outlet rod 331 moves to the opening position D2 so that the outlet packing part 335 opens the outlet 317.

The outlet elastic member 339 is coupled with an outer surface of the outlet rod 331 to elastically press the outlet rod 331 so that the outlet rod 331 maintains the closing position D1. The outlet elastic member 339 comprises a coil spring. The outlet rod 331 comprises an engaging protrusion 332 supporting the outlet elastic member 339. Thus, the outlet rod 331 can be stably pressed by the outlet elastic member 339.

An elastic supporting part 316 is provided to a rear part of the housing 310 to support the outlet elastic member 339 According to an embodiment of the present invention, the inside diameter of the second elastic supporting part 316 is bigger than the outer diameter of the outlet rod 331. Thus, the housing 310 can support the outlet elastic member 339, and the outlet elastic member 339 can stably press the outlet rod 331.

Alternatively, the outlet 317 and the outlet regulating part 330 may have such a configuration as the water supplying apparatus 200 according to the first embodiment of the present invention.

Hereinafter, an operation of the water supplying apparatus 300 will be described by referring to FIGS. 2A to 2C.

In FIG. 2B, in the case that a user is supplied with a cold water, if the user pushes the lever 337 backward, the lever 337 rotates about the hinge shaft 333 to move the outlet rod 331 to the opening position D2. The user should apply a force to overcome an elastic force of the outlet elastic member 339. As the outlet rod 331 moves to the opening position D2, the outlet 317 is opened. Here, since the inlet elastic member 326 of the inlet regulating part 320 presses the inlet rod 321 to maintain the cold water supplying position C1, the cold water supplied from the cold water pipe 15 can flow out through the outlet 317 via the cold water inlet 315 and the cold water channel 324b.

In FIG. 2C, in the case that a user is supplied with a hot water, the user pushes the operating part 327 of the inlet regulating part 320 to move the inlet rod 321 to the hot water supplying position C2. The user should apply a force to overcome an elastic force of the inlet elastic member 326. Depending on moving of the inlet rod 321, the hot water channel 324a connects the hot water inlet 313 with the outlet 317 and the cold water inlet 315 is closed by the inlet rod 321. Then, if the user pushes the lever 337, the hot water supplied from the hot water pipe 74 can flow out through the outlet 317 via the hot water inlet 313 and the hot water channel 324a.

Accordingly, the water supplying apparatus 300 can efficiently and stably supply cold water and hot water by means of a same (i.e., single) lever 337, thereby simplifying the configuration thereof and reducing cost and the size thereof.

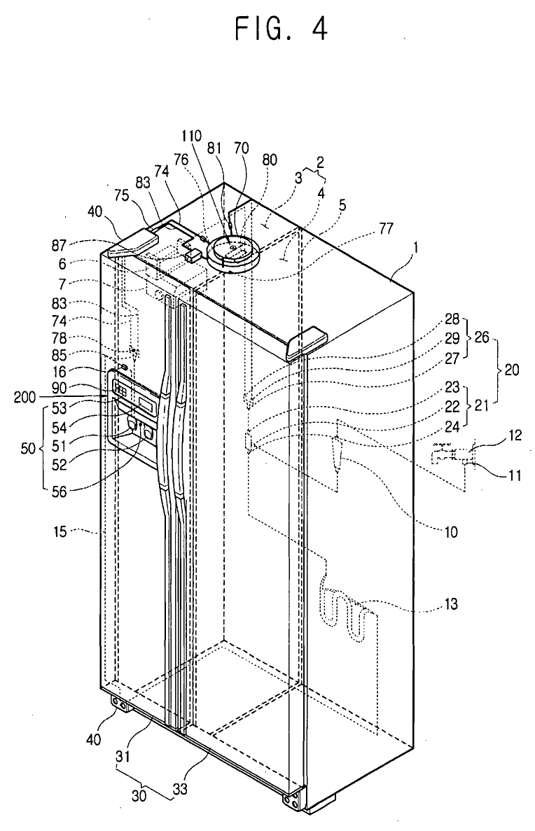

Hereinafter, a refrigerator according to an embodiment of the present invention will be described by referring to FIGS. 1A to 1C, and 4.

As shown therein, a refrigerator according to an embodiment of the present invention comprises a main body 1, a door 30 opening and closing a storage compartment 2, and the water supplying apparatus 200 including a dispenser 50 shown in FIGS. 1A to 1C. Alternatively, the refrigerator according to an embodiment of the present invention may comprise the water supplying apparatus 300 shown in FIGS. 2A to 3B.

The storage compartment 2 comprises a freezing compartment 3 and a refrigerating compartment 4 partitioned by a central wall 5. A pair of doors 30 (i.e., 31 and 33) opens and closes front openings of the respective compartments 3 and 4, and a plurality of door guards (not shown) are provided to an inner side of the doors 30 to store bottles, etc.

An ice maker 6 is provided to an upper part of the freezing compartment 3, and an ice storing part 7 is provided under the ice maker 6 to store ice made by the ice maker 6. A shelf (not shown) and a drawer (not shown) are provided to a lower part of the freezing compartment 3 to separately store foods.

The refrigerating compartment 4 comprises a water purifying part 10 purifying water receiving from the outside, a cold water tank 13 storing the water purified by the water purifying part 10, and a shelf (not shown) and a drawer (not shown), etc. separately storing foods. A cold water pipe 15 connects the cold water tank 13 and a cold water inlet 215 of a housing 210. A cold water valve 16 is provided to the cold water pipe 15 to control a flow therethrough. The cold water valve 16 may comprise a solenoid valve.

The water purifying part 10 is provided to the refrigerating compartment 4, and purifies water supplied from the outside. The water purifying part 10 comprises a water purifying filter filtering impurities out of water supplied through an external connecting part 11. The water purifying part 10 is detachably provided to be replaced.

The refrigerator according to the embodiment of the invention comprises a diverging valve 20 supplying water purified by the water purifying part 10 to the ice maker 6, the cold water tank 13 and a hot water tank 70. The diverging valve 20 comprises a first diverging valve 21 and a second diverging valve 26.

A first end part of the external connecting part 11 is connected with an external water source 12, a water purifier (not shown), etc., and a second end part thereof is connected to the water purifying part 10.

According to an embodiment of the present invention, The first diverging valve 21 is a three-way valve. The first diverging valve 21 comprises an inlet 22 connected to the purifying part 10, a first outlet 23 connected with the second diverging valve 26, and a second outlet 24 connected to the cold water tank 13.

According to an embodiment of the present invention, the second diverging valve 26 is a three-way valve, and comprises an inlet 27 connected with the first outlet 23 of the first diverging valve 21, a first outlet 28 connected with the ice maker 6, and a second outlet 29 connected with the hot water tank 70.

A controller (not shown) controls the first diverging valve 21 so that the first and second outlets 23 and 24 thereof are selectively opened or closed, and controls the second diverging valve 26 so that the first and second outlets 28 and 29 thereof are selectively opened or closed.

The doors 30 open and close the front openings of the freezing compartment 3 and the refrigerating compartment 4. The doors 30 comprise a freezing compartment door 31 opening and closing the front opening of the freezing compartment 3, and a refrigerating compartment door 33 opening and closing the front opening of the refrigerating compartment 4. The dispenser 50 is provided to a front surface of the freezing compartment door 31 to receive water and ice made by the ice maker 6. A home bar (not shown) or a home pad (not shown) having a TV, an internet function, etc. may be provided to a front surface of the refrigerating compartment door 33.

The refrigerator according to the embodiment of the present invention comprises a hinge part 40 rotatably coupling the door 30 to the main body 1. The hinge part 40 comprises an upper hinge part disposed to an upper part of the main body 1, and a lower hinge part disposed to a lower part thereof.

The hinge part 40 comprises a hollow hinge shaft (not shown) provided to the main body 1, and a hinge shaft coupling part (not shown) provided to the door 30. The hollow hinge shaft accommodates a hot water pipe 74 and a circulation pipe 83 therein.

In FIG. 4, the dispenser 50 comprises a water lever 51 (referring to 237 in FIG. 1A) for receiving water, an ice lever 52 for receiving ice, and an input part 53 to select cold water or hot water, the amount of water, etc. The dispenser 50 comprises a display part 54 displaying information about selection through the input part 53, an operating state information of the refrigerator, etc. The dispenser 50 comprises a heater switch 90.

The ice lever 52 is connected with the ice storing part 7 storing ice made by the ice maker 6. The ice lever 52 comprises a same configuration as the lever 237 in FIG. 1A. If a force is applied to the ice lever 52, ice is supplied, and if the force is withdrawn therefrom, ice stops being supplied. Alternatively, according to an embodiment of the present invention, the ice lever 52 comprises a button or a touch screen provided to the input part 53, or other various configurations.

A user selects ice or water, hot water or cold water, the amount thereof through the input part 53. The input part 53 comprise a mechanical button, a lead switch, a touch screen, etc. The input part 53 of the present invention is not limited to any particular type of mechanism, and may vary accordingly.

The display part 54 displays inputted information through the input part 53, the temperatures of cold water and hot water, an operating state of the refrigerator, etc. In the case that the input part 53 is provided as a touch screen type, the display part 54 is provided integrally with the input part 53.

The dispenser 50 comprises a valve switch 56 opening and closing the cold water valve 16 and a hot water valve 85. The valve switch 56 is provided in rear of the water lever 51 to interlock with the water lever 51. The valve switch 56 comprise a lead valve, a sensor, etc.

The hot water tank 70 is provided between the water purifying part 10 and the dispenser 50. The hot water tank 70 is provided to an upper part of the main body 1. The hot water tank 70 comprises an inlet through which water purified by the water purifying part 10 flows in, a storing part storing water supplied through the input, and an outlet through which water stored in the storing part flows out. The hot water tank 70 is connected with the dispenser 50 through the hot water pipe 74. A vapor ventilating unit 110 may be provided to an upper surface of the hot water tank 70.

The hot water pipe 74 connects the outlet of the hot water tank 70 with a hot water inlet 213 of the dispenser 50 shown in FIG. 1A. The hot water pipe 74 is disposed inside of the hollow hinge shaft of the hinge part 40. The hot water pipe 74 penetrated through the hollow hinge shaft is buried into a foaming space of the door 30. Thus, although the hot water tank 70 is disposed to an upper part of the main body 1, the freezing compartment door 31 can rotate without being interfered therefrom.

A protecting member 75 may be provided to an outer surface of the hot water pipe 74. The protecting member 75 may comprise a spring or an elastic member surrounding a bent part of the hot water pipe 74 to protect the bent part thereof.

The hot water tank 70 comprises a heater 80 heating water stored in the storing part, a water gauge 76 measuring the amount of water stored therein, and a first temperature sensor 77 measuring the temperature of water stored therein.

The heater 80 is provided to the hot water tank 70 to heat water stored therein. The heater 80 may be accommodated inside the hot water tank 70, buried to a part thereof, or attached to an outer surface thereof.

The refrigerator according to the embodiment of the present invention comprises a supplying valve 81 controlling a flow of water supplied to the hot water tank 70. The supplying valve 81 is disposed between the water purifying part 10 and the hot water tank 70. The supplying valve 81 is opened or closed so that water purified by the water purifying part 10 is supplied to the hot water tank 70 or stops being supplied thereto. The supplying valve 81 is disposed to a pipe connected to the inlet of the hot water tank 70. Alternatively, according to an embodiment of the present invention, the second diverging valve 26 performs the same function as the supplying valve 81. The second outlet 29 of the second diverging valve 26 can be opened or closed so that water is supplied to the hot water tank 70 or stops being supplied.

The refrigerator according to the embodiment of the present invention comprises the heater switch 90 controlling power supplying to the heater 80. The heater switch 90 is provided for selecting one of a normal mode in which the heater 80 selectively heats or stops, and a stop mode in which the heater 80 stops heating the water.

According to embodiments of the present invention, the heater switch 90 is integrally provided with the input part 53, or separately provided to the dispenser 50.

The circulation pipe 83 branches from the hot water pipe 74 to connect with the hot water tank 70. Thus, the hot water tank 70, the hot water pipe 74 and the circulation pipe 83 are connected one another. The circulation pipe 83 branches from a part of the hot water pipe 74 adjacent to the dispenser 50. The circulation pipe 83 is accommodated inside the hollow hinge shaft together with the hot water pipe 74.

The hot water valve 85 is provided to a diverging part of the hot water pipe 74 and the circulation pipe 83. The hot water valve 85 prevents water in the hot water pipe 74 between the hot water tank 70 and the hot water valve 85 and water in the circulation pipe 83 from being supplied to the dispenser 50. The hot water valve 85 comprises an opening state and a closing state. In the opening state, the hot water valve 85 blocks between the hot water pipe 74 and the circulation pipe 83, and supplies water in the hot water pipe 74 between the hot water tank 70 and the hot water valve 85 to the dispenser 50. In the closing state, the hot water valve 85 communicates the hot water pipe 74 with the circulation pipe 83, and prevents water in the hot water pipe 74 between the hot water tank 70 and the hot water valve 85 from being supplied to the dispenser 50.

The hot water valve 85 interlocks with the valve switch 56. In the case that the hot water is selected by means of the input part 53 and the water lever 51 is pushed, the valve switch 56 makes the hot water valve 85 become the opening state so that the hot water pipe 74 communicates through the hot water valve 85. Thus, the hot water stored in the hot water pipe 74 and the hot water tank 70 can be supplied to the dispenser 50. In the case that a force applied to the water lever 51 is withdrawn, the valve switch 56 makes the hot water valve 85 become the closing state so that the hot water in the hot water pipe 74 between the hot water tank 70 and the hot water valve 85 is prevented from being supplied to the dispenser 50. The hot water valve 85 is preferably disposed to be adjacent to the water lever 51 so that the hot water valve 85 efficiently and stably interlocks with the water lever 51. The hot water valve 85 comprises a solenoid valve.

A pump 87 is provided to the circulation pipe 83. The pump 87 forcedly circulates water in the hot water pipe 74 between the hot water tank 70 and the hot water valve 85 and water in the circulation pipe 83 to the hot water tank 70. The pump 87 is disposed to an upper part of the main body 1. The pump 87 may circulate water to sequentially pass the hot water tank 70, the hot water pipe 74 and the circulation pipe 83, or oppositely thereto.

The refrigerator according to the embodiment of the present invention comprises a second temperature sensor 78 provided to the hot water valve 85. The second temperature sensor 78 measures the temperature of water in the hot water valve 85, and informs the controller.

The refrigerator according to the embodiment of the present invention comprises a timer (not shown) measuring time for controlling the heater 80.

The second temperature sensor 78 is disposed to the hot water valve 85. Alternatively, according to an embodiment of the present invention, the second temperature sensor 78 is disposed to the circulation pipe 83, or the hot water pipe 74 between the hot water tank 70 and the hot water valve 85. The second temperature sensor 78 is provided to measure the temperature of water in at least one area of the hot water valve 85, the hot water pipe 74 between the hot water tank 70 and the hot water valve 85, and the circulation pipe 83.

Hereinafter, a controlling method for the heater 80 of the refrigerator according to the embodiment of the present invention will be described.

When the normal mode is selected to the heater switch 90, the controller controls the supplying valve 81 and the heater 80 so that water in the hot water tank 70 maintains a predetermined amount range and a predetermined temperature range.

When the stop mode is selected to the heater switch 90, the controller closes the supplying valve 81 and stops heating of the heater 80. Thus, although water in the hot water tank 70 is supplied to a user, since the supplying valve 81 is closed, the hot water tank 70 can be emptied. Thus, a user can conveniently manage cleanliness, etc. of the hot water tank 70, and reduce an unnecessary heating of the heater 80, thereby reducing power consumption.

Hereinafter, a first controlling method for the pump 87 of the refrigerator according to the embodiment of the present invention will be described.

The controller controls the pump 87 to operate with a predetermined period. An operating period of the pump 87 can be determined based on an experiment result. The operating period of the pump 87 can be variously determined depending on a setting temperature, an environment, etc. The operating period of the pump 87 is determined as an average time for which the temperature of water in the hot water valve 85 becomes lower than a predetermined operating temperature after a hot water is supplied to a user.

The controller controls the pump 87 to operate for a predetermined operating time. An operating time of the pump 87 can be determined based on an experiment result. The operating time of the pump 87 is preferably determined as an average time for which the temperature of water in the hot water valve 85 reaches a predetermined stop temperature after the pump 87 is driven. Thus, a user can obtain a hot water with a uniform temperature.

Hereinafter, a second controlling method for the pump 87 of the refrigerator according to the embodiment of the present invention will be described.

The controller controls the pump 87 based on the temperature measured by the second temperature sensor 78. If the controller determines that the temperature measured by the second temperature sensor 78 is lower than a predetermined operating temperature, the controller drives the pump 87 to circulate water. After the pump 87 is driven, if the controller determines that the temperature measured by the second temperature sensor 78 is higher than a predetermined stop temperature, the controller stops driving of the pump 87. Here, alternatively, the pump 87 may be driven for a predetermined time.

Hereinafter, an ice supplying process of the refrigerator according to the embodiment of the present invention will be described.

Water supplied through the external connecting part 11 is purified by the water purifying part 10. The purified water flows in the first diverging valve 21 through the inlet 22 thereof. Then, the water flows out through the first outlet 23 of the first diverging valve 21 to flow in the second diverging valve 26 through the inlet 27 thereof. Then, the water flows out through the first outlet 28 of the second diverging valve 26 to be supplied to the ice maker 6. Then, the ice maker 6 makes ice out of the supplied water. Then, the ice made by the ice maker 6 is separated therefrom to be stored in the ice storing part 7. The controller controls the first and second diverging valves 21 and 26 to supply water to the ice maker 6 so that the ice storing part 7 maintains a uniform amount of ice. Then, when a user pushes the ice lever 52, ice is supplied from the ice storing part 7 to the dispenser 50.

Hereinafter, a cold water supplying process of the refrigerator according to the embodiment of the present invention will be described.

A user selects cold water, and pushes the water lever 51. The valve switch 56 interlocks with operating of the water lever 51 to open and close the cold water valve 16. When the valve switch 56 is operated, the cold water valve 16 is opened. Then, referring to FIG. 1B, a cold water is supplied.

Hereinafter, a hot water supplying process of the refrigerator according to the embodiment of the present invention will be described by referring to FIGS. 1C, 4 and 5.

As shown therein, water supplied through the external connecting part 11 is purified by the water purifying part 10. The purified water flows in the first diverging valve 21 through the inlet 22 thereof. Then, the water flows out through the first outlet 23 of the first diverging valve 21 to flow in the second diverging valve 26 through the inlet 27 thereof. Then, the water flows out through the second outlet 29 of the second diverging valve 26 to be supplied to the hot water tank 70. Then, the heater 80 heats water stored in the hot water tank 70.

When a user selects hot water, and pushes the water lever 51. The valve switch 56 interlocks with operating of the water lever 51 to open and close the hot water valve 85. When the valve switch 56 is operated, the hot water valve 85 is opened. Then, as shown in FIG. 1C, hot water is supplied. After being supplied with the hot water, a user withdraws a force applied to the water lever 51. Then, the hot water valve 85 interlocks with the valve switch 56 to be in the closing state. Thus, water in the hot water pipe 74 between the hot water tank 70 and the hot water valve 85 can be prevented from being supplied to the dispenser 50.

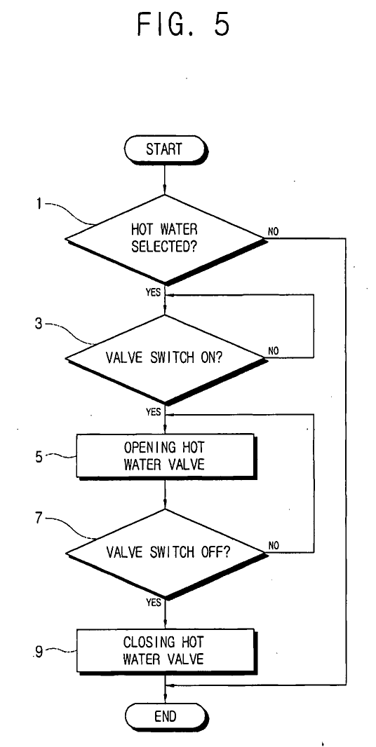

Hereinafter, a control method for supplying a hot water will be described in detail by referring to FIG. 5.

As shown in FIG. 5, in operation 1, the control part determines whether hot water is selected. If the hot water is selected in operation 1, the process moves to operation 3, where the control part determines whether the valve switch 56 is turned on. If the hot water is not selected, the control part ends controlling.

If the valve switch 56 is turned on in operation 3, the process moves to operation 5, where the controller opens the hot water valve 85.

Then, the process moves to operation 7, where the controller determines whether the valve switch 56 is turned off. If the valve switch 56 is turned off in operation 7, the process moves to operation 9, where the controller closes the hot water valve 85. If it is determined that the valve switch 56 is not turned off in operation 7, the controller performs the operation 5.

The refrigerator according to an embodiment of the present invention comprises various diverging configurations from the water purifying part 10 to the ice maker 6, the cold water tank 13 and the hot water tank 70. For example, according to an embodiment of the present invention, the diverging valve 20 is provided as a four-way valve so that water supplied from the water purifying part 10 to the diverging valve 20 can be respectively supplied to the ice maker 6, the cold water tank 13 and the hot water tank 70.

The hot water tank 70 of the refrigerator according to an embodiment of the present invention is positioned to an upper part of the main body 1. Thus, the hot water tank 70 can be distanced from the storage compartment 2 to interpose a foaming material therebetween. Thus, heat of the hot water tank 70 can be prevented from being transmitted to the storage compartment 2, thereby reducing power consumption and enhancing reliability thereof.

The hot water pipe 74 and the circulation pipe 83 of the refrigerator according to the present invention are disposed inside the hollow hinge shaft. Thus, although the hot water tank 70 is positioned to an upper part of the main body 1, the door 30 rotates without being interfered thereby.

The vapor ventilating unit 110 of the refrigerator according to an embodiment of the present invention ventilates the hot water tank 70. Thus, the vapor pressure of the hot water tank 70 can be safely maintained.

The refrigerator according to an embodiment of the present invention can supply a cold water and a hot water by using one water lever 51 and one outlet 217 referring to FIG. 1C, thereby reducing the number of components and the volume of the dispenser 50.

Although the valve switch 56 is operated when a user pushes the water lever 51, the refrigerator according to the present invention prevents the hot water valve 85 from being opened as long as hot water is not selected through the input part 53, thereby enhancing safety.

The refrigerator according to the present invention includes the hot water valve 85 and the inlet regulating part 220 referring to FIG. 1C, thereby enhancing safety with respect to ejecting of hot water.

As described above, the present invention provides a water supplying apparatus and a refrigerator having the same supplying hot water and cold water by using one (i.e., a single) lever.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A water supplying apparatus comprising:
a cold water pipe to supply a cold water;
a hot water pipe to supply a hot water;
and a dispenser connected with the cold water pipe and the hot water pipe, the dispenser comprising:
a housing comprising a cold water inlet through which cold water supplied from the cold water pipe flows in, a hot water inlet through which hot water supplied from the hot water pipe flows in, and a single outlet through which the hot water or the cold water selectively flows out,
an inlet regulating part to reciprocate in the housing, to thereby selectively open the cold water inlet and the hot water inlet; and
an outlet regulating part to open and close the outlet.

2. The water supplying apparatus according to claim 1, wherein when the inlet regulating part opens the cold water inlet and the outlet regulating part opens the outlet, the dispenser supplies the cold water, and when the inlet regulating part opens the hot water inlet and the outlet regulating part opens the outlet, the dispenser supplies the hot water.

3. The water supplying apparatus according to claim 2, wherein the inlet regulating part comprises:
a rod provided in the housing to move between a cold water supplying position at which the cold water inlet is opened and the hot water inlet is closed, and a hot water supplying position at which the hot water inlet is opened and the cold water inlet is closed;
a hot water packing part provided to the rod to close the hot water inlet when the rod is at the cold water supplying position;
a cold water packing part provided to the rod to close the cold water inlet when the rod is at the hot water supplying position;
an elastic member to elastically press the rod toward the cold water supplying position; and
an operating part to operate the rod.

4. The water supplying apparatus according to claim 2, wherein the inlet regulating part comprises:
a rod provided in the housing to move between a cold water supplying position at which the cold water inlet is opened and the hot water inlet is closed, and a hot water supplying position at which the hot water inlet is opened and the cold water inlet is closed;
a water channel part to connect the cold water inlet with the outlet, when the rod is at the cold water supplying position, and connecting the hot water inlet with the outlet when the rod is at the hot water supplying position;
an elastic member to elastically press the rod toward the cold water supplying position; and
an operating part to operate the rod.

5. The water supplying apparatus according to claim 4, wherein the water channel part comprises a groove formed around an outer surface of the rod.

6. The water supplying apparatus according to claim 4, wherein the water channel part comprises a through hole formed to the rod.

7. The water supplying apparatus according to claim 5, wherein the water channel part comprises a cold water channel and a hot water channel distanced from each other.

8. The water supplying apparatus according to claim 6, wherein the water channel part comprises a cold water channel and a hot water channel distanced from each other.

9. A refrigerator comprising a water supplying apparatus, the water supplying apparatus comprising:
a cold water pipe to supply cold water, a hot water pipe to supply hot water, and a dispenser connected with the cold water pipe and the hot water pipe, the dispenser comprising:
a housing comprising a cold water inlet through which a cold water supplied from the cold water pipe flows in, a hot water inlet through which a hot water supplied from the hot water pipe flows in, and an outlet through which the hot water or cold water flows out,
an inlet regulating part to reciprocate in the housing, to thereby selectively open the cold water inlet and the hot water inlet, and
an outlet regulating part to open and close the outlet.

10. The refrigerator according to claim 9, wherein the inlet regulating part comprises:
a rod provided in the housing to move between a cold water supplying position at which the cold water inlet is opened and the hot water inlet is closed, and a hot water supplying position at which the hot water inlet is opened and the cold water inlet is closed;
a hot water packing part provided to the rod to close the hot water inlet when the rod is at the cold water supplying position;
a cold water packing part provided to the rod to close the cold water inlet when the rod is at the hot water supplying position;
an elastic member to elastically press the rod toward the cold water supplying position; and
an operating part to operate the rod.

11. The refrigerator according to claim 9, wherein the inlet regulating part comprises:
a rod provided in the housing to move between a cold water supplying position at which the cold water inlet is opened and the hot water inlet is closed, and a hot water supplying position at which the hot water inlet is opened and the cold water inlet is closed;
a water channel part to connect the cold water inlet with the outlet, when the rod is at the cold water supplying position, and connecting the hot water inlet with the outlet when the rod is at the hot water supplying position;
an elastic member to elastically press the rod toward the cold water supplying position; and
an operating part to operate the rod.

12. The refrigerator to claim 11, wherein the water channel part comprises a groove formed around an outer surface of the rod.

13. The refrigerator according to claim 11, wherein the water channel part comprises a through hole formed to the rod.

14. The refrigerator according to claim 12, wherein the water channel part comprises a cold water channel and a hot water channel distanced from each other.

15. The refrigerator according to claim 13, wherein the water channel part comprises a cold water channel and a hot water channel distanced from each other.

16. The refrigerator according to claim 9, wherein the dispenser comprises an input part to allow a user to select the cold water or the hot water.

17. The refrigerator according to claim 16, further comprising:
a hot water valve to open and close the hot water pipe;
a valve switch to operate the hot water valve; and
a control part to control the valve switch to open the hot water valve, when the hot water is selected through the input part.

18. The refrigerator according to claim 17, further comprising a cold water valve to open and close the cold water pipe,
wherein the valve switch operates the cold water valve, and the control part controls the valve switch to open the cold water valve when the cold water is selected through the input part.

19. The refrigerator according to claim 18, wherein the valve switch interlocks with the outlet regulating part.

20. The refrigerator according to claim 10, wherein the dispenser comprises an input part to allow a user to select the cold water or the hot water.

21. The refrigerator according to claim 20, further comprising:
a hot water valve to open and close the hot water pipe;
a valve switch to operate the hot water valve; and
a control part to control the valve switch to open the hot water valve when the hot water is selected through the input part.

22. The refrigerator according to claim 21, further comprising a cold water valve to open and close the cold water pipe,
wherein the valve switch operating the cold water valve, and the control part controls the valve switch to open the cold water valve when the cold water is selected through the input part.

23. The refrigerator according to claim 22, wherein the valve switch interlocks with the outlet regulating part.

24. The refrigerator according to claim 11, wherein the dispenser comprises an input part to allow a user to select the cold water or the hot water.

25. The refrigerator according to claim 24, further comprising:
a hot water valve to open and close the hot water pipe;
a valve switch to operate the hot water valve; and
a control part to control the valve switch to open the hot water valve when the hot water is selected through the input part.

26. The refrigerator according to claim 25, further comprising a cold water valve to open and close the cold water pipe,
wherein the valve switch operating the cold water valve, and the control part controls the valve switch to open the cold water valve when the cold water is selected through the input part.

27. The refrigerator according to claim 26, wherein the valve switch interlocks with the outlet regulating part.

28. A water supplying apparatus for a refrigerator, comprising:
a cold water pipe and a hot water pipe to respectively supply cold water and hot water;
a dispenser connected with the cold water pipe and the hot water pipe to discharge the cold water and hot water supplied; and
a single lever which is operated to selectively supply the cold water and hot water discharged from the dispenser.

29. The water supplying apparatus according to claim 28, wherein the dispenser comprises:
a cold water inlet and a hot water inlet through which cold water and hot water respectively flows from the cold water pipe and the hot water pipe;
an inlet regulating part reciprocating in the dispenser to selectively open the cold water inlet and the hot water inlet; and
a single outlet through which the cold water and the hot water selectively flows out.

30. The water supplying apparatus according to claim 29, wherein hot water pipe and the cold water pipe are arranged in parallel.

31. The water supplying apparatus according to claim 29, wherein the inlet regulating part comprises an inlet rod to move between a cold water supplying position and a hot water supplying position wherein the cold water inlet and the hot water inlet is selectively opened or closed.

32. The water supplying apparatus according to claim 31, further comprising:
a water channel to connect the cold water inlet to the outlet when the inlet rod is at the cold water supplying position, and to connect the hot water inlet to the outlet when the inlet rod is at the hot water supplying position.

33. The water supplying apparatus according to claim 32, wherein the water channel comprises a groove formed around an outer surface of the inlet rod.

34. The water supplying apparatus according to claim 32, wherein the water channel comprises a through hole formed to the inlet rod.

35. The water supplying apparatus according to claim 32, wherein the water channel comprises a cold water channel and a hot water channel distanced from each other and corresponding to the cold water inlet and the hot water inlet, respectively.

36. The water supplying apparatus according to claim 35, wherein the cold water inlet is of a size corresponding to the cold water channel, and the hot water inlet is of a size corresponding to the hot water channel.

37. The water supplying apparatus according to claim 29, wherein the outlet comprises a pipe shape bent downwardly, to protrude from a lower part of a housing of the water supplying apparatus.

38. The water supplying apparatus according to claim 31, wherein the inlet regulating part further comprises an inlet elastic member to elastically press the inlet rod, and an operating part to operate the inlet rod.

39. The water supplying apparatus according to claim 38, wherein the inlet elastic member is a coil spring.

40. The water supplying apparatus according to claim 38, wherein a rear part of the inlet rod to which the inlet elastic member is coupled comprises a diameter smaller than that of a front part of the inlet rod.

41. A refrigerator comprising:
a water supplying apparatus comprising:
a cold water pipe and a hot water pipe to respectively supply cold water and hot water,
a dispenser connected with the cold water pipe and the hot water pipe to discharge the cold water and hot water supplied,
an outlet through which the cold water and hot water discharged from the dispenser selectively flows out, and
a single lever which is operated to selectively supply the cold water and hot water discharged from the dispenser such that cold water and hot water selectively flows out of the same outlet.
